(19) United States
(12) Patent Application Publication
(10) Pub. No.: US 2026/0042165 A1
(43) Pub. Date: Feb. 12, 2026

(54) BC CELL SERIES WELDING MACHINE FOR HALF-CELLS, WELDING WIRES, AND ADHESIVE TAPES

(71) Applicant: Guangdong Kelongwei Automation Equipment Co., Ltd., Dongguan (CN)

(72) Inventors: Jincai SU, Dongguan (CN); Chunfu CHEN, Dongguan (CN)

(21) Appl. No.: 19/365,335

(22) Filed: Oct. 22, 2025

(30) Foreign Application Priority Data
Apr. 23, 2025 (CN) 202510517210.6

(51) Int. Cl. B23K 20/00; B23K 101/40; B23K 103/00

(52) U.S. Cl. CPC B23K 20/004; B23K 2101/40; B23K 2103/56

(57) ABSTRACT

The present invention discloses a BC cell string welding machine for half-cells, welding wires, and adhesive tapes, including five mechanisms. The silicon wafer handling mechanism warms laser-cut dual half-cells; the flipping/turning mechanism flips, separates, turns and positions dried ones for photographic inspection; the assembly mechanism cuts and hot-melts adhesive tape between half-cells; the welding wire cutting/placement mechanism pulls, cuts left/right odd/even-column wires to position them; the welding mechanism places cut wires and welds adhesive-bonded cell strings. No manual intervention, it enables efficient, quality BC cell string production.

### CROSS-REFERENCE TO RELATED APPLICATIONS

This application claims the benefit of priority from Chinese Patent Application No. 202510517210.6, field on Apr. 23, 2025. The content of the aforementioned application, including any intervening amendments thereto, is incorporated by reference in its entirety.

### TECHNICAL FIELD

The present invention relates to the technical field of silicon wafer string welding, particularly to a BC cell string welding machine for half-cells, welding wires, and adhesive tapes.

### BACKGROUND

Photovoltaic solar silicon wafers constitute the core component of solar power generation systems and represent the most valuable part of solar power generation systems. The function of silicon wafers is to convert solar energy into electrical energy, and then electrical energy is stored in batteries or directly powers loads. Currently, customers using BC cells (full name: back-contact cells, compatible with multiple routing configurations) require string welding treatment of multiple half-cell silicon wafers. This process involves flipping and turning laser-cut half-cell silicon wafers, threading them into cell strings using hot melt adhesive tapes, and performing infrared string welding treatment by matching the cut welding wires.

### SUMMARY

One objective of the present invention is to provide a BC cell string welding machine for half-cells, wires, and adhesive tapes. This machine fully automates the drying, flipping, and turning of dual half-cells. Hot melt adhesive tapes string the half-cells together, and welding wires are strung to form cell strings. This process eliminates manual intervention, conserves resources, and enhances efficiency.

To achieve this objective, the present invention employs the following technical solutions:
A BC cell string welding machine for half-cells, welding wires, and adhesive tapes, including a silicon wafer handling mechanism, a silicon wafer flipping and turning mechanism, a silicon wafer and adhesive tape assembly mechanism, a welding wire cutting and placement mechanism, and a welding wire welding mechanism. The silicon wafer handling mechanism performs warming and heating treatment on laser-cut dual half-cells; the wafer flipping and turning mechanism flips the dried dual half-cells, separates them, turns and positions them for photographic inspection; the silicon wafer and adhesive tape assembly mechanism cuts the stretched adhesive tape and adheres it between the half-cells via hot melting; the wire cutting and placement mechanism undertakes pull-out and cutting of odd-numbered and even-numbered column welding wires on the left and right sides respectively, ensuring wire positioning; the welding wire welding mechanism places the cut welding wires beneath and positions the adhesive-bonded cell strings for string welding.

As a preferred technical solution, the silicon wafer handling mechanism includes a half-cell handling bracket, a handling translation module, and a drying heating chamber. The half-cell handling bracket is fixed with a handling support plate, the handling support plate features handling fixation absorption holes distributed along the front-to-back direction. A handling lifting motor is mounted on the drive end of the handling translation module, with a handling lifting cam connected to the drive end of the handling lifting motor. A handling lifting module is positioned beneath the handling support platform. The upper end of the handling lifting module connects to a handling slat and the handling slat is positioned centrally on the handling support plate. The handling lifting cam controls the vertical movement of the handling slat. The drying heating chamber is mounted above the handling support plate.

As a preferred technical solution, the drying heating chamber is fixed on both sides at the center of the handling support plate, a drying heating rod is installed inside the drying heating chamber, a vent plate is provided above the drying heating rod, and a drying heating cooling fan is installed above the drying heating chamber.

As a preferred technical solution, the silicon wafer flipping mechanism includes a flipping bracket, a translation clamping bracket, a half-cell turning X-axis module, a half-cell turning Z-axis module, and a half-cell converging bracket. The flipping bracket is rotatably connected to a flipping shaft, and the flipping frame is fixed on the flipping shaft; the translation clamping bracket has translation slats on both sides, and the translation belt moves on the translation slats, with translation absorption holes provided on the translation belt; The translation clamping arms are arranged on both sides of the translation slats, with translation clamping wheels installed on the clamping arms. The half-cell turning Z-axis module is mounted on the drive end of the half-cell turning X-axis module. Two turning cylinders are movably mounted along the Y-axis direction on the drive end of the half-cell turning Z-axis module, with turning suction cups connected to the drive ends of the turning cylinders. The end of the half-cell converging bracket is provided with a converging base frame, with converging arms installed on both sides and the rear of the converging base frame.

As a preferred technical solution, the converging base frame is provided with converging front and rear sliding rails, converging left and right sliding rails and converging synchronizing wheels, and the converging synchronizing wheels are connected with a converging synchronizing belt in a transmission way, the converging synchronizing belt is connected with the converging arm at the rear side, the converging arm at the rear side slides on the converging front and rear sliding rails, and a converging fixing plate is fixed on the converging arm at the rear side. The converging fixing plate is provided with a converging guide groove, the converging arms at two sides slide on the converging left and right sliding rails, the converging arms at two sides are provided with converging guide wheels, and the converging guide wheels move in the converging guide grooves.

As a preferred technical solution, the assembly mechanism of silicon wafers and adhesive tapes includes an adhesive tape slitting structure and a melt adhesive conveying structure; the adhesive tape slitting structure includes an adhesive tape slitting bracket, an adhesive tape chuck and an adhesive tape cutter, wherein an adhesive tape transverse module is installed on the adhesive tape slitting bracket along the left and right directions, and the adhesive tape chuck and the adhesive tape cutter are both connected to the drive end of the adhesive tape transverse module; the melt adhesive conveying structure includes a melt adhesive adhering bracket and a melt adhesive platform, wherein the melt adhesive adhering bracket is provided with two melt adhesive front and rear modules along the front and rear directions, the drive ends of each of melt adhesive front and rear modules are provided with a melt adhesive vertical sliding rail, and a melt adhesive vertical slider is connected below the melt adhesive platform, the melt adhesive vertical slider slides on the melt adhesive vertical sliding rail, and the melt adhesive platform is internally inserted with a melt adhesive heating tube.

As a preferred technical solution, the drive end of the adhesive tape transverse module is provided with an adhesive tape pulling plate and an adhesive tape cutting plate. The lower end of the adhesive tape pulling plate is fitted with an adhesive tape front cylinder and an adhesive tape front holder. The drive end of the adhesive tape front cylinder is hinged to the adhesive tape chuck, wherein the adhesive tape chuck and the front adhesive tape holder clamp the front end of the adhesive tape. The lower end of the adhesive tape cutting plate is mounted with a adhesive tape rear cylinder, an adhesive tape cutting cylinder, and a rear adhesive tape holder. The adhesive tape cutter is mounted on the drive end of the adhesive tape cutting cylinder, and the drive end of the adhesive tape rear cylinder and the rear adhesive tape holder clamp the rear end of the adhesive tape.

As a preferred technical solution, the welding wire cutting and placement mechanism includes two welding wire feeders, a welding wire transverse module, two welding wire cutting assemblies, a welding wire bidirectional clamping assembly, and a welding wire positioning bracket. The welding wire positioning bracket is positioned between the two welding wire feeders, with the two wire cutting assemblies positioned above both ends of the wire positioning bracket. The bidirectional wire clamping assembly is mounted on the drive end of the wire transverse module, reciprocating between the two wire cutting assemblies to draw a wire from the wire feeder and place it onto the welding wire positioning bracket.

As a preferred technical solution, the bidirectional welding wire clamping assembly includes a welding wire clamping support and a welding wire sliding shaft. A row of welding wire lower clamps and a row of welding wire upper clamps are mounted on each side of the welding wire clamping support, wherein the welding wire lower clamps are fixed to the welding wire clamping support, and an internal support cavity is provided within the welding wire clamping support. The upper end of the support cavity is connected to a support air pipe joint. The welding wire sliding shaft moves transversely within the support cavity, and the welding wire upper clamps are hinged to the end of the welding wire sliding shaft.

As a preferred technical solution, the welding wire welding mechanism includes a welding wire transfer structure, a silicon wafer transfer structure, an infrared welding structure, a welding support structure, and a string welding blanking structure, wherein the wire transfer structure picks up the wire and places it onto the welding support structure; the silicon wafer transfer structure places the silicon wafer array connected to the adhesive tape onto the welding support structure holding the wire; the welding support structure moves the silicon wafer array together with the wire to the position below the infrared welding structure for string welding; and the string welding blanking structure removes the string-welded silicon wafers.

The beneficial effects of the present invention are as follows: A BC cell string welding machine for half-cells, welding wires, and adhesive tapes is provided. The entire process requires no manual intervention, ensuring a stream string welding processing, and rapidly producing BC cell strings meeting customer requirements with guaranteed quality.

### BRIEF DESCRIPTION OF THE DRAWINGS

The present invention will now be described in further detail with reference to the drawings and embodiments.

FIG. 1 is a schematic diagram of the overall structure of the BC cell string welding machine for half-cells, welding wire, and adhesive tape according to the embodiment;

FIG. 2 is a schematic diagram of the first overall structure of the silicon wafer handling mechanism according to the embodiment;

FIG. 3 is a schematic diagram of the second overall structure of the silicon wafer handling mechanism according to the embodiment;

FIG. 4 is an internal structural diagram of the drying heating chamber according to the embodiment;

FIG. 5 is an overall structural diagram of the silicon wafer flipping and turning mechanism according to the embodiment;

FIG. 6 is a structural diagram of the flipping section according to the embodiment;

FIG. 7 is a structural diagram of the translation clamping section according to the embodiment;

FIG. 8 is a structural diagram of of the turning section according to the embodiment;

FIG. 9 is a structural diagram of the converging section according to the embodiment;

FIG. 10 is a structural diagram of the converging base frame according to the embodiment;

FIG. 11 is an overall structural diagram of the silicon wafer and adhesive tape assembly mechanism according to the embodiment;

FIG. 12 is a structural diagram of the adhesive tape cutting mechanism according to the embodiment;

FIG. 13 is a structural diagram of the adhesive tape transverse module section according to the embodiment;

FIG. 14 is a structural diagram of the melt adhesive platform section according to the embodiment;

FIG. 15 is an overall structural diagram of the welding wire cutting and placement mechanism according to the embodiment;

FIG. 16 is a schematic diagram of the first structure of the welding wire cutting assembly according to the embodiment;

FIG. 17 is a schematic diagram of the second structure of the welding wire cutting assembly according to the embodiment;

FIG. 18 is a structural diagram of the bidirectional wire clamping according to the embodiment;

FIG. 19 is a partial structural diagram of the wire positioning bracket according to the embodiment;

FIG. 20 is a schematic diagram of the upper end structure of the wire positioning seat according to the embodiment;

FIG. 21 is an overall structural diagram of the welding wire welding mechanism according to the embodiment;

FIG. 22 is a structural diagram of the wire transfer structure according to the embodiment;

FIG. 23 is a structural diagram of the wire transfer holder according to the embodiment;

FIG. 24 is a partial structural diagram of the silicon wafer transfer structure according to the embodiment;

FIG. 25 is a structural diagram of the infrared welding structure according to the embodiment;

FIG. 26 is a structural diagram of of the welding support structure according to the embodiment;

FIG. 27 is a partial structural diagram of the welding support structure according to the embodiment;

FIG. 28 is a structural diagram of the string welding blanking structure according to the embodiment.

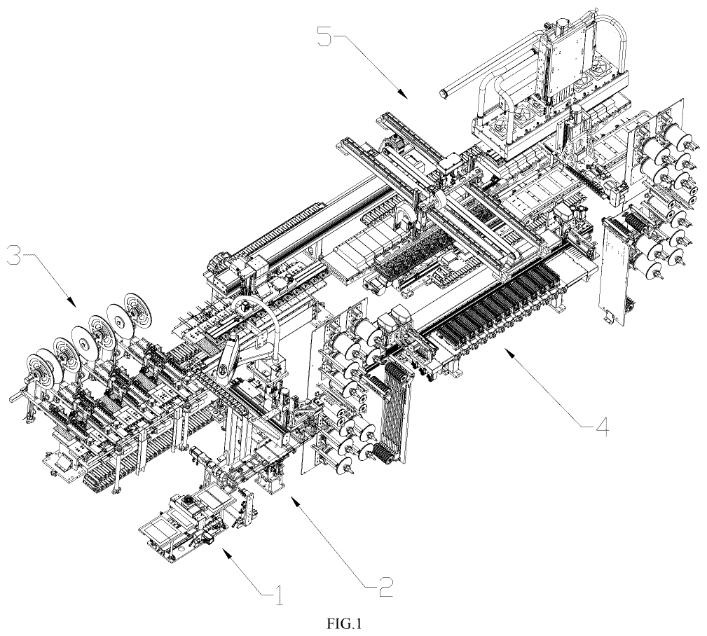

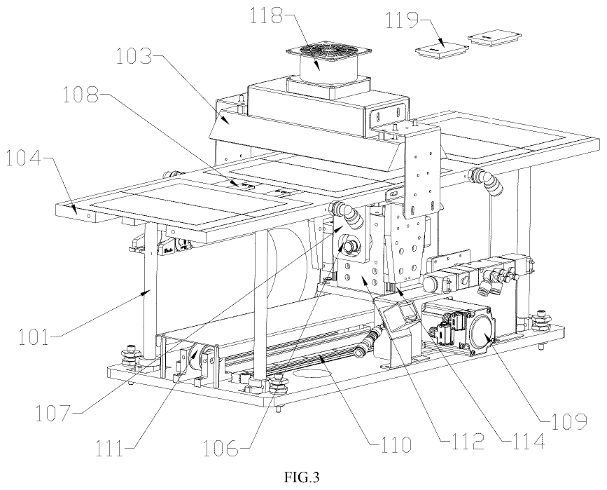

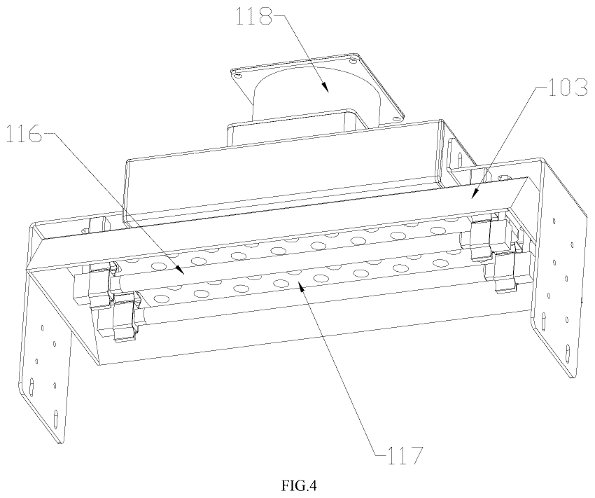

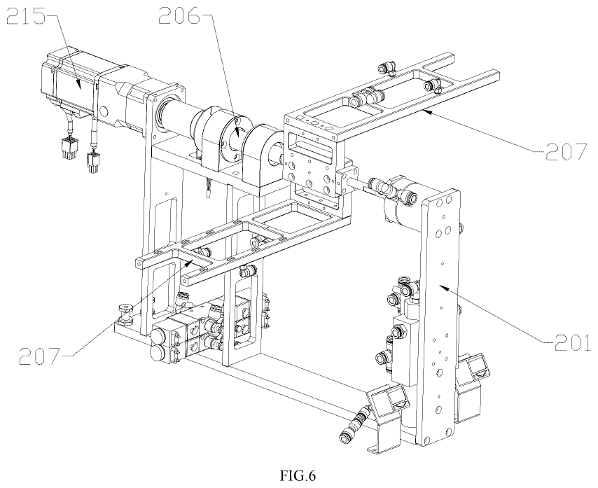

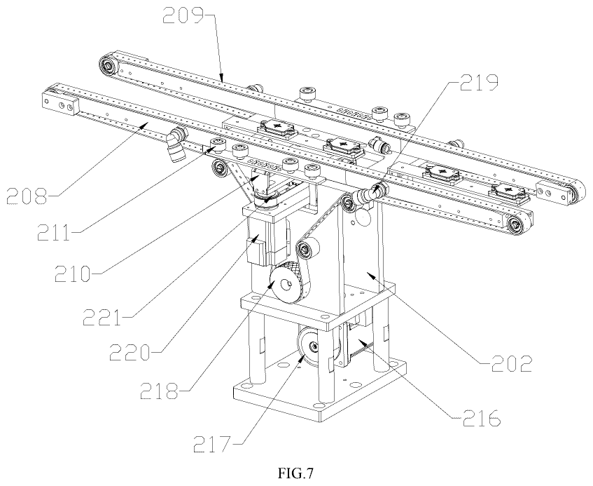

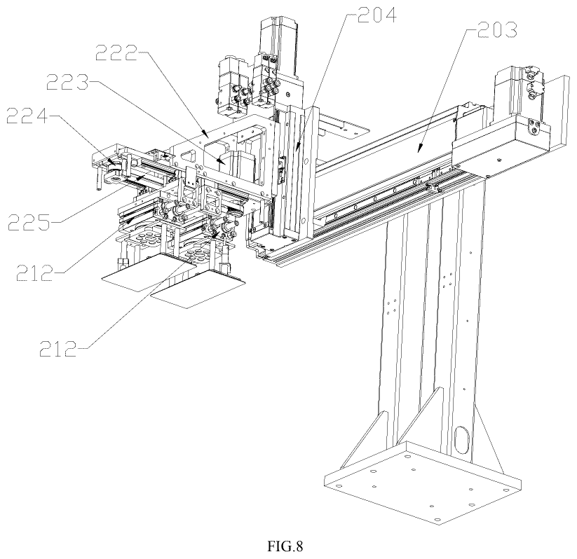

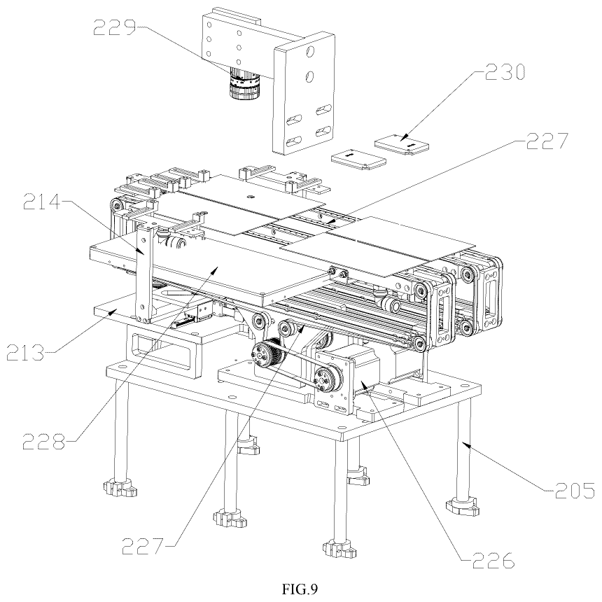

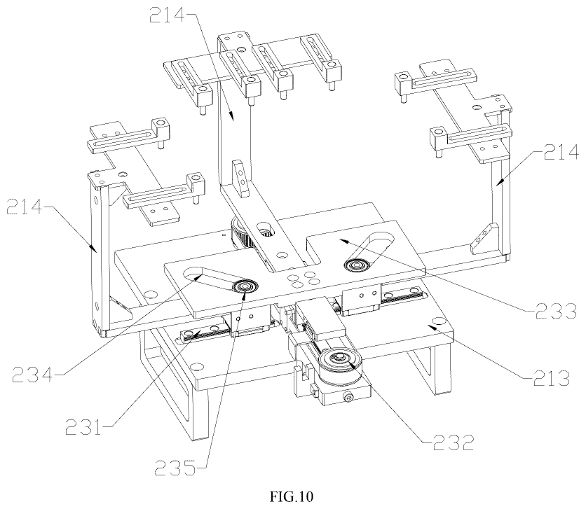

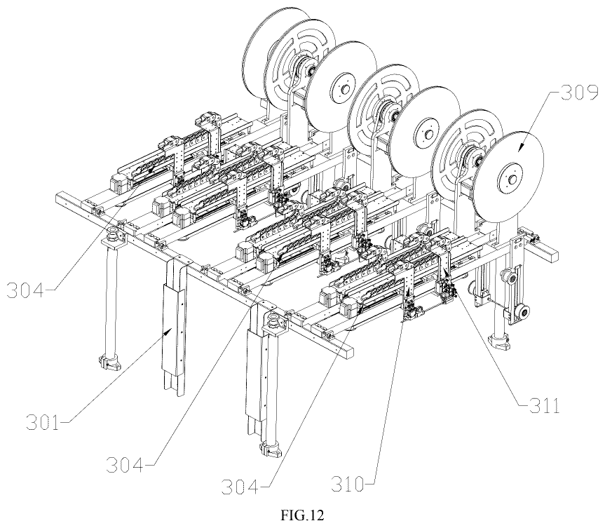

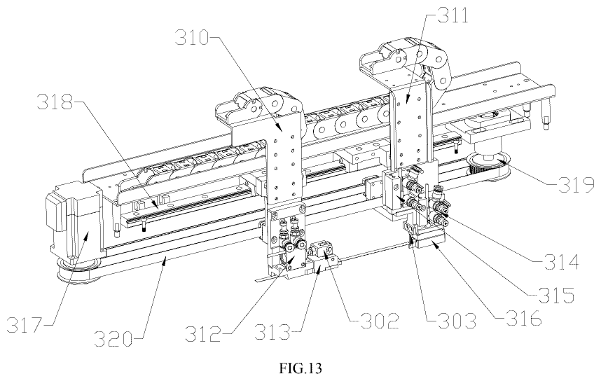

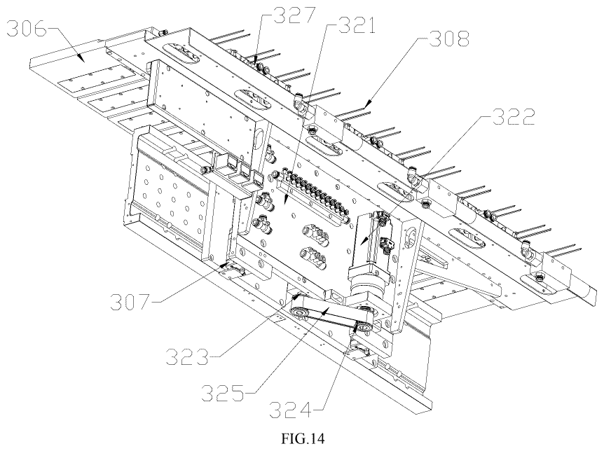

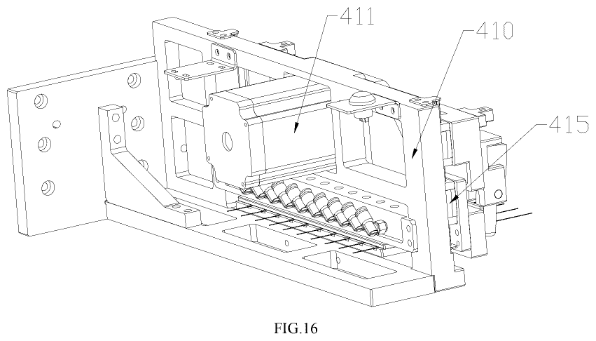

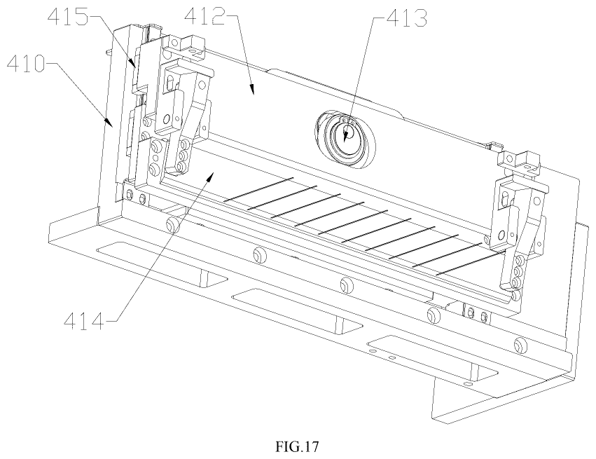

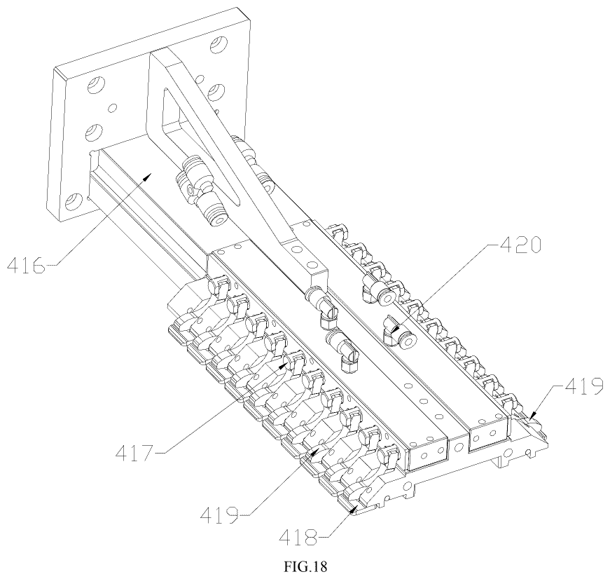

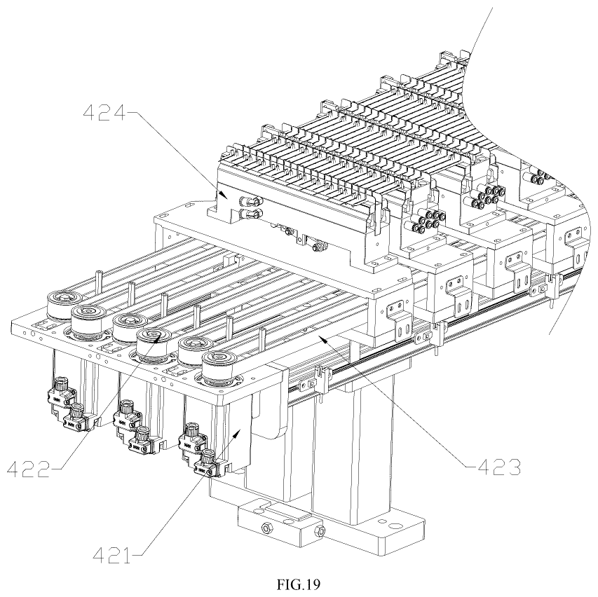

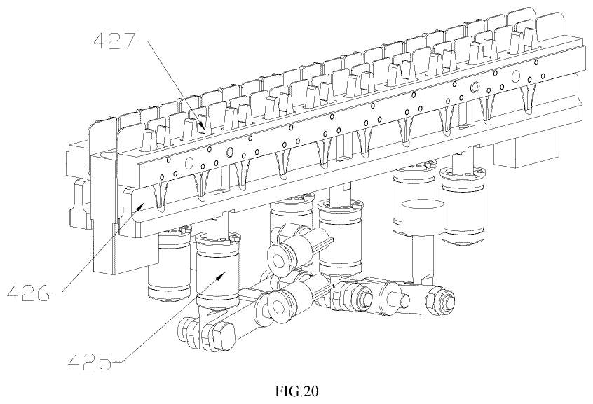

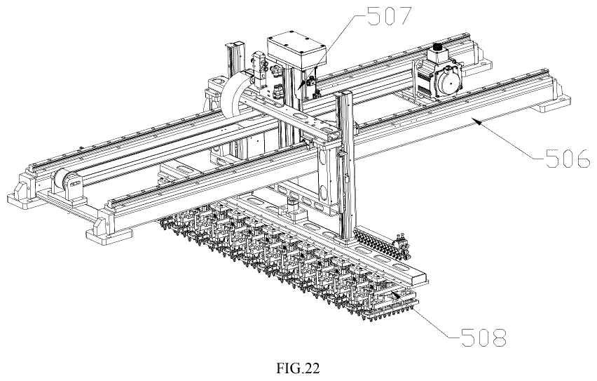

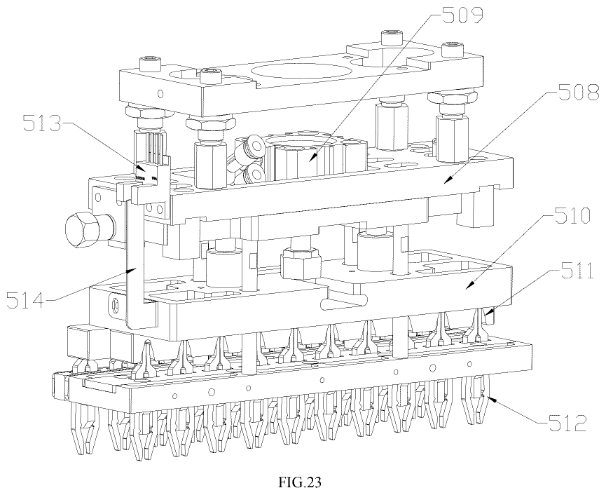

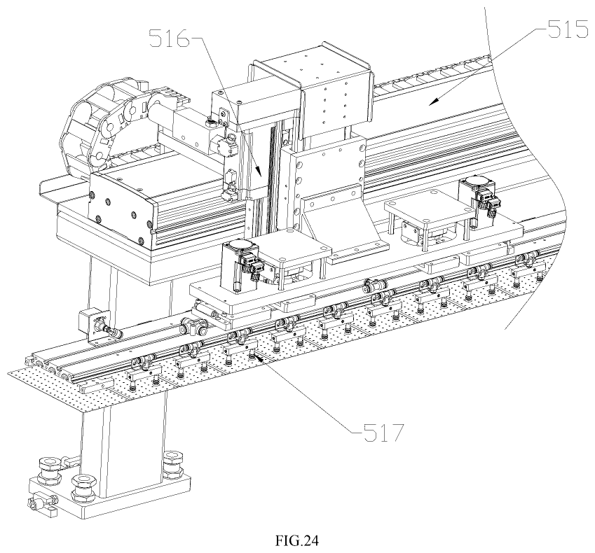

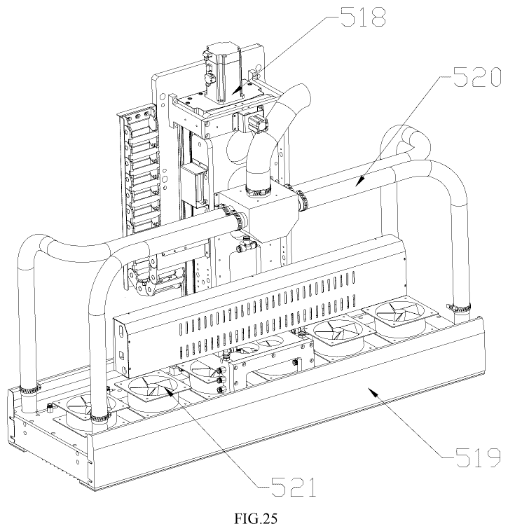

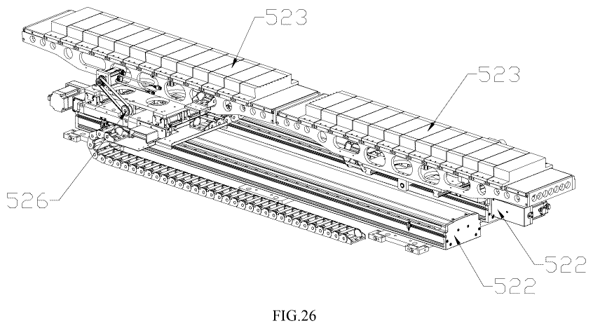

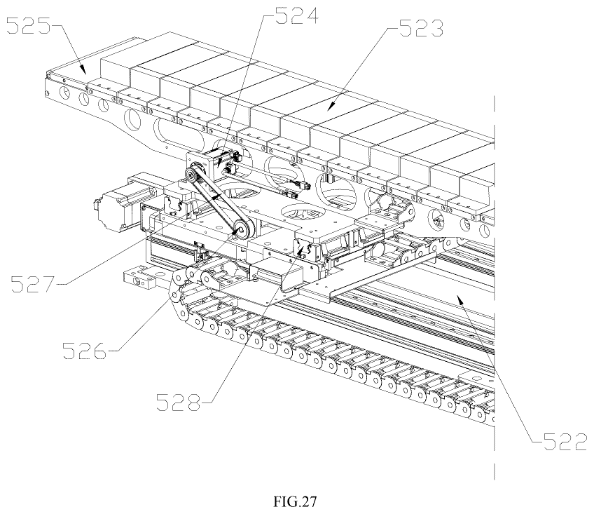

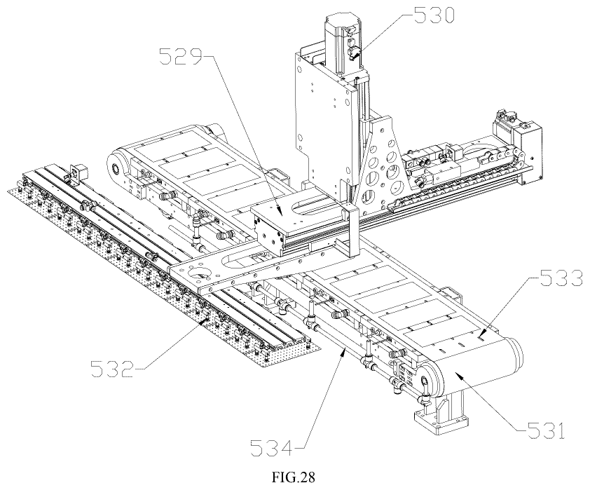

In FIGS. 1 to 28:
1. Wafer handling mechanism; 101. Half-cell handling bracket; 102. Handling translation module; 103. Drying heating chamber; 104. Handling support plate; 105. Handling lifting motor; 106. Handling lifting cam; 107. Handling lifting module; 108. Handling slat; 109. Handling translation motor; 110. Handling translation sliding rail; 111. Handling translation synchronizing wheel; 112. Handling translation support; 113. Handling lifting guide plate; 114. Handling lifting sliding rail; 115. Handling air pipe joint; 116. Drying heating rod; 117. Vent plate; 118. Dryingheating fan; 119. Reflector;
2. Silicon wafer flipping and turning mechanism; 201. Flipping support; 202. Translation clamping bracket; 203. Half-cell turning X-axis module; 204. Half-cell turning Z-axis module; 205. Half-cell converging bracket; 206. Flipping axis; 207. Flipping frame; 208. Translation slat; 209. Translation belt; 210. Translation clamping arm; 211. Translation clamping wheel; 212. Turning cylinder; 213. Converging base frame; 214. Converging arm; 215. Turning motor; 216. Translation motor; 217. Translation synchronizing wheel; 218. Translation driving wheel; 219. Translation air pipe joint; 220. Translation clamping motor; 221. Translation clamping synchronizing wheel; 222. Half-cell turning frame; 223. Half-cell spacing motor; 224. Half-cell spacing synchronizing wheel; 225. Half-cell spacing synchronizing belt; 226. Half-cell converging track motor; 227. Half-cell converging track conveyor belt; 228. Half-cell positioning light source; 229. Half-cell positioning camera; 230. Half-cell signal reflector; 231. Converging left/right sliding rails; 232. Converging synchronizing wheel; 233. Converging fixing plate; 234. Converging guide groove; 235. Converging guide wheel;
3. Silicon wafer and adhesive tape assembly mechanism; 301. Adhesive tape cutting bracket; 302. Adhesive tape chuck; 303. Adhesive tape cutter; 304. Adhesive tape transverse module; 305. Melt adhesive adhering bracket; 306. Melt adhesive platform; 307. Melt adhesive vertical slider; 308. Melt adhesive heating tube; 309. Adhesive tape feeding tray; 310. Adhesive tape pulling plate; 311. Adhesive tape cutting plate; 312. Adhesive tape front cylinder; 313. Adhesive tape front holder; 314. Adhesive tape rear cylinder; 315. Adhesive tapecutting cylinder; 316. Adhesive tape rear holder; 317. Adhesive tape transverse motor; 318. Adhesive tape transverse sliding rail; 319. Adhesive tape transverse synchronizing wheel; 320. Adhesive tape transverse synchronizing belt; 321. Melt adhesive vertical plate; 322. Melt adhesive vertical transfer motor; 323. Melt adhesive lifting screw; 324. Melt adhesive lifting synchronizing wheel; 325. Melt adhesivelifting synchronizing belt; 326. Platform absorption hole; 327. Platform air pipe joint;
4. Welding wire cutting and placement mechanism; 401. Welding wire feeder; 402. Welding wire transverse module; 403. Welding wire cutting assembly; 404. Welding wire bidirectional clamping assembly; 405. Welding wire positioning bracket; 406. Welding wire spool; 407. Tensioning frame; 408. Tensioning wheel; 409. Welding wire lifting pedestal; 410. Welding wire cutting support; 411. Welding wire cutting motor; 412. Welding wire cutting vertical plate; 413. Welding wire cutting cam; 414. Welding wire cutter; 415. Welding wire cutting slider; 416. Welding wire clamping support; 417. Welding wire sliding shaft; 418. Welding wire lower clamp; 419. Welding wire upper clamp; 420. Support air pipe joint; 421. Welding wire positioning motor; 422. Welding wire positioning synchronizing wheel; 423. Welding wire positioning synchronizing belt; 424. Welding wire positioning seat; 425. Welding wire positioning cylinder; 426. Welding wire positioning plate; 427. Welding wire positioning clamp;
5. Welding wire welding mechanism; 501. Welding wire transfer structure; 502. Silicon wafer transfer structure; 503. Infrared welding structure; 504. Welding support structure; 505. String welding blanking structure; 506. Welding wire transfer transverse module; 507. Welding wire transfer longitudinal module; 508. Welding wire transfer holder; 509. Welding wire transfer cylinder; 510. Welding wire transfer stop plate; 511. Welding wire transfer V groove; 512. Wire transfer clip; 513. Welding wire transfer sensor; 514. Welding wire transfer signal wafer; 515. Silicon wafer transfer transverse module; 516. Silicon wafer transfer longitudinal module; 517. Silicon wafer transfer suction nozzle; 518. Infrared lifting module; 519. Infrared welding frame; 520. Air duct; 521. Exhaust fan; 522. Welding support front and rear modules; 523. Welding positioning module; 524. Welding support left and right motors; 525. Welding support side table; 526. Welding support left and right synchronizing wheels; 527. Welding support left and right synchronizing belts; 528. Welding support left and right sliding rails; 529. String welding blanking transverse module; 530. String welding blanking transverse module; 531. String welding blanking track; 532. String welding blanking suction nozzle; 533. Blanking adsorption hole; 534. Blanking air pipe.

### DETAILED DESCRIPTION OF EMBODIMENTS

The technical solution of the present invention will be further explained by specific embodiments with reference to the attached drawings.

As shown in FIG. 1, in this embodiment, a BC cell string welding machine for half-cells, welding wires, and adhesive tapes, includes a silicon wafer handling mechanism 1, a silicon wafer flipping and turning mechanism 2, a silicon wafer and adhesive tape assembly mechanism 3, a welding wire cutting and placement mechanism 4, and a welding wire welding mechanism 5. The silicon wafer handling mechanism 1 performs warming and heating treatment on laser-cut dual half-cells; the wafer flipping and turning mechanism 2 flips the dried dual half-cells, separates them, turns and positions them for photographic inspection; the silicon wafer and adhesive tape assembly mechanism 3 cuts the stretched adhesive tape and adheres it between the half-cells via hot melting; the wire cutting and placement mechanism 4 undertakes pull-out and cutting of odd-numbered and even-numbered column welding wires on the left and right sides respectively, ensuring wire positioning; the welding wire welding mechanism 5 places the cut welding wires beneath and positions the adhesive-bonded cell strings for string welding.

The following is a more specific structural description of this embodiment.

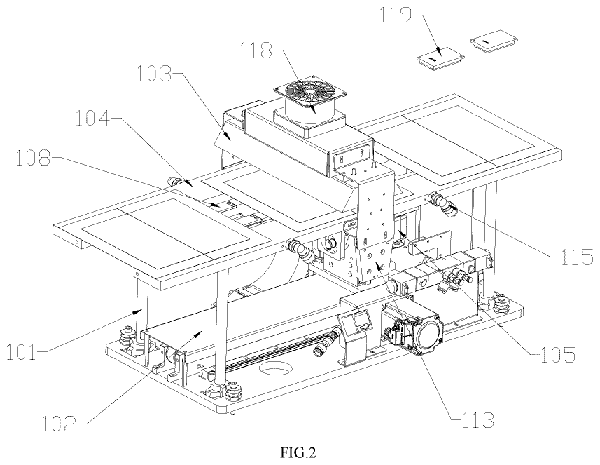

As shown in FIGS. 2 to 4, the silicon wafer handling mechanism 1 includes a half-cell handling bracket 101, a handling translation module 102, and a drying heating chamber 103. The half-cell handling bracket 101 is fixed with a handling support plate 104, the handling support plate 104 features handling fixation absorption holes distributed along the front-to-back direction. A handling lifting motor 105 is mounted on the drive end of the handling translation module 102, with a handling lifting cam 106 connected to the drive end of the handling lifting motor 105. A handling lifting module 107 is positioned beneath the handling support platform. The upper end of the handling lifting module 107 connects to a handling slat 108 and the handling slat 108 is positioned centrally on the handling support plate 104. The handling lifting cam 106 controls the vertical movement of the handling slat 108. The drying heating chamber is mounted above the handling support plate 104.

The handling slat 108 is driven by the handling translation module 102 to extend into the half-cell cutting machine to pull out the laser-cut half-cells. The handling lifting motor 105 controls the lifting of the handling slat 108 through the handling lifting cam 106, so that the front, middle and rear positions of the half-cells are changed on the half-cell handling bracket 101. In the middle position, the upper drying heating chamber 103 dries and heats the laser-cut position between the two half-cells, and is moved to the rear of the handling support plate 104 for subsequent transportation when the handling slat 108 is lifted and shifted backward.

The handling translation module 102 includes a handling translation motor 109 and a handling translation sliding rail 110. The drive end of the handling translation motor 109 and one end of the half-cell handling bracket 101 are both connected with a handling translation synchronizing wheel 111, and a handling translation synchronizing belt is connected between the handling translation synchronizing wheels 111 in a transmission way. A handling translation support 112 is fixedly connected with the handling translation synchronizing belt, and the handling translation support 112 is slidably connected along the handling translation sliding rail 110, and the lifting motor 105 is fixed on the handling translation support 112.

When a half-cell silicon wafer moves, the lifting motor 105 controls the lifting of the handling slat 108 through the lifting cam 106, so that the half-cell silicon wafer leaves the support plate 104, and then the handling translation motor 109 drives the handling translation support 112 to move backward along the handling translation sliding rail 110 through the rotating handling translation synchronizing wheel 111 and the handling translation synchronizing belt. When the half-cell silicon wafer moves below the drying heating chamber 103, the handling translation motor 109 stops, and the handling lifting motor 105 controls the handling slat 108 to descend, so that the half-cell silicon wafer falls on the handling support plate 104. At this time, the handling fixing absorption hole absorbs and fixes the half-cell silicon wafer. When the drying heating is finished, the handling fixing absorption hole loosens the half-cell silicon wafer, then the handling slat 108 is lifted and moved backwards, and then the handling slat 108 moves down below the handling support plate 104. Repeat the above operation.

Both sides of the half-cell handling brackets 101 are provided with handling lifting guide plates 113, the upper ends of handling lifting guide plates 113 are connected to the handling slats 108. The handling lifting guide plates 113 are fixed on both sides of the handling sliding supports, the lifting guide plates 113 slide vertically along the lifting sliding rails 114. When the lifting slats 108 move up and down, the lifting guide plates 113 rise and fall along the lifting sliding rails 114, providing a guiding function.

The handling lifting module 107 features a cam movement hole, within which the handling lifting cam 106 moves. During the lifting process, the movement of the cam within this hole drives the handling slat 108 to move vertically.

The side of the handling support plate 104 is provided with a handling air pipe joint 115. The handling air pipe joint 115 communicates with the handling fixing absorption hole. The handling air pipe joint 115 is responsible for air intake and exhaust to control the suction and release of the current half-cell silicon wafer by the handling fixing absorption hole.

The drying heating chamber 103 is fixed on both sides at the center of the handling support plate 104. A drying heating rod 116 is installed inside the drying heating chamber 103, with a vent plate 117 positioned above the drying heating rod 116. A drying heating cooling fan 118 is mounted above the drying heating chamber 103. For the dual half-cells below the drying heating chamber 103, the drying heating rod 116 dries the laser-cut positions, while high-temperature gas is expelled by the drying heating cooling fan 118 above.

A reflector 119 is positioned above the rear end of the half-cell handling bracket 101, while a handling signal sensor is located below the rear end of the half-cell handling bracket 101. When the dried dual half-cells move above the handling signal sensor, they block the reflector 119, signaling the subsequent mechanism to remove the half-cell silicon wafers.

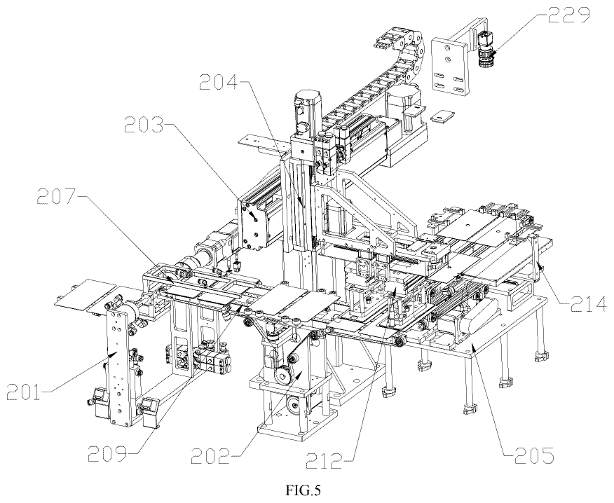

As shown in FIGS. 5 to 10, the silicon wafer flipping and turning mechanism 2 includes a flipping bracket 201, a translation clamping bracket 202, a half-cell turning X-axis module 203, a half-cell turning Z-axis module 204, and a half-cell converging bracket 205. A flipping shaft 206 is rotatably connected to the flipping bracket 201. A flipping frame 207 is fixed on the flipping shaft 206. The translation clamping bracket 202 has translation slats 208 on both sides, with a translation belt 209 movably mounted on the translation slat 208. The translation belt 209 is provided with translation absorption holes. Translation clamping arms 210 are mounted on both sides of the translation slats 208. Translation clamping arms 210 are fitted with translation clamping wheels 211. The half-cell turning Z-axis module 204 is mounted on the drive end of the half-cell turning X-axis module 203. Two turning cylinders 212 move along the Y-axis direction on the drive end of the half-cell turning Z-axis module 204. The drive ends of the turning cylinders 212 are connected to turning suction cups. The end of the half-cell converging bracket 205 is provided with a converging base frame 213. Both sides and the rear of the converging base frame 213 are provided with converging arms 214.

After the dried half-cells enter the flipping bracket 201, the flipping shaft 206 rotates to flip the half-cells positioned on the flipping frame 207 and feed them into the translation clamping bracket 202. Under the action of the translation absorption holes of the translation belt 209, the flipping shaft 206 firmly sucks the half-cells, and then along the direction of the translation slat 208, drives to between the translation clamping arms 210. After the half-cell silicon wafer is released, the translation clamping arm 210 positions the half-cell silicon wafer toward the center before moving it to the rear side. The half-cell turning X-axis module 203 controls the half-cell turning Z-axis module 204 to move above the half-cell silicon wafer. The half-cell turning Z-axis module 204 controls two turning cylinders 212 to move downward to absorb the half-cell silicon wafer respectively via the turning suction cup. After separating along the Y-axis direction, the turning cylinders 212 simultaneous turn half-cells, and then return the half-cells to the converging bracket 205. Through the converging action of the converging arm 214, the position of the dual half-cells is fixed to facilitate docking with the rear mechanism.

A flipping motor 215 is arranged on one side of the flipping bracket 201. The drive end of the flipping motor 215 connects to one end of the flipping shaft 206. The flipping frame 207 is provided with flipping absorption holes. The flipping motor 215 controls the rotation of the flipping shaft 206. The flipping frame 207 sucks the half-cell silicon wafer through the flipping absorption holes before performing the flipping operation.

A translation motor 216 is mounted at the lower end of the translation clamping bracket 202. Both the drive end of the translation motor 216 and the middle section of the translation clamping bracket 202 are provided with translation synchronizing wheels 217. Translation synchronizing wheels 217 are connected via a belt in a transmission way. The shafts on both sides of the translation synchronizing wheels 217 are connected to the translation driving wheel 218. A translation belt 209 is connected to the translation driving wheel 218 in a transmission way. A translation air pipe joint 219 is mounted on the outer side of the translation slat 208, the translation air pipe joint 219 communicates with the translation absorption hole through the translation slat 208. A translation clamping motor 220 is mounted on the upper end of the translation clamping bracket 202. The drive end of the translation clamping motor 220 is connected to a translation clamping synchronizing wheel 221. The translation clamping synchronizing wheel 221 is positioned on the outer side of the translation slat 208. The translation clamping synchronizing wheels 221 are connected via a translation clamping synchronizing belt. The translation clamping arm 210 is fixed to the translation clamping synchronizing belt.

The translation motor 216 drives the translation belt 209 to move along the translation slat 208 through the mutual engagement between the translation synchronizing wheel 217 and the translation driving wheel 218, thereby driving the adsorbed half-cell silicon wafer to move backward. The translation air pipe joint 219 controls the negative pressure in the translation absorption holes to adhere to the half-cell silicon wafer. The translation clamping motor 220, driven by the translation clamping synchronizing wheel 221 and translation clamping synchronizing belt, controls the translation clamping arm 210 to move toward the translation slat 208, stabilizing the position of the half-cell silicon wafer at the center.

A half-cell turning frame 222 is mounted on the drive end of the half-cell turning Z-axis module 204. The half-cell turning frame 222 carries a half-cell motor 223 and a half-cell synchronizing wheel 224, with the half-cell motor 223 connected to the half-cell synchronizing wheel 224. The half-cell synchronizing wheels 224 are connected via a half-cell synchronizing belt 225. The turning cylinder 212 is fixed to the half-cell synchronizing belt 225. The half-turning Z-axis module 204 controls the half-cell turning frame 222 to move down. After the two turning suction cups lift one half-cell silicon wafer respectively, the half-cell motor 223 pulls the two turning cylinders 212 apart via the half-cell synchronizing wheel 224 and half-cell synchronizing belt 225 to facilitate turning. After turning the dual half-cells, the turning cylinders 212 converge back. The half-cell turning X-axis module 203 then places the turned dual half-cells into the half-cell converging bracket 205.

The lower end of the half-cell converging bracket 205 is provided with a half-cell converging track motor 226. The drive end of the half-cell converging track motor 226 is connected to a half-cell converging track synchronizing wheel in a transmission way. The half-cell converging track synchronizing wheel is connected to a half-cell converging track conveyor belt 227 in a transmission way.

A half-cell positioning light source 228 and a half-cell signal sensor are mounted on the half-cell converging bracket 205. A half-cell positioning camera 229 and a half-cell signal reflector 230 are positioned above the half-cell converging bracket 205.

The converging base frame 213 is provided with converging front and rear sliding rails, converging left and right sliding rails 231 and converging synchronizing wheels 232, and the converging synchronizing wheels 232 are connected with a converging synchronizing belt in a transmission way, the converging synchronizing belt is connected with the converging arm 214 at the rear side, the converging arm 214 at the rear side slides on the converging front and rear sliding rails, and a converging fixing plate 233 is fixed on the converging arm 214 at the rear side. The converging fixing plate 233 is provided with a converging guide groove 234, the converging arms 214 at two sides slide on the converging left and right sliding rails 231, the converging arms 214 at two sides are provided with converging guide wheels 234, and the converging guide wheels 235 move in the converging guide grooves.

The half-cell converging track motor 226 moves the dual half-cells backward via the half-cell converging track synchronizing wheel and the half-cell converging track conveyor belt 227. After induction of the half-cell signal sensor, the half-cell positioning camera 229 performs defect detection on the dual half-cells. Finally, when rotating, the converging synchronizing wheel 232 drives the converging synchronizing belt to move. The rear-side converging arm 214 pulls back, while simultaneously controlling both converging arms 214 to synchronously converge toward the center under the action of the converging guide groove 234 and converging guide wheel 235, bringing the positions of the two halves together, and preparing for subsequent adhesive tape application.

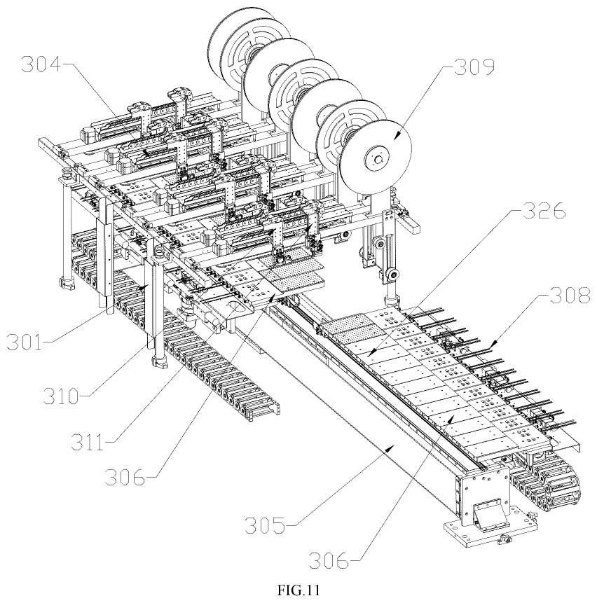

As shown in FIGS. 11 to 14, the assembly mechanism of silicon wafers and adhesive tapes 3 includes an adhesive tape slitting structure and a melt adhesive conveying structure; the adhesive tape slitting structure includes an adhesive tape slitting bracket 301, an adhesive tape chuck 302 and an adhesive tape cutter 303, wherein an adhesive tape transverse module 304 is installed on the adhesive tape slitting bracket 301 along the left and right directions, and the adhesive tape chuck 302 and the adhesive tape cutter 303 are both connected to the drive end of the adhesive tape transverse module 304; the melt adhesive conveying structure includes a melt adhesive adhering bracket 305 and a melt adhesive platform 306, wherein the melt adhesive adhering bracket 305 is provided with two melt adhesive front and rear modules along the front and rear directions, the drive ends of each group of melt adhesive front and rear modules are provided with a melt adhesive vertical sliding rail, and a melt adhesive vertical slider 307 is connected below the melt adhesive platform 306, the melt adhesive vertical slider 307 slides on the melt adhesive vertical sliding rail, and the melt adhesive platform 306 is internally inserted with a melt adhesive heating tube 308.

The adhesive tape chuck 302 grips the front end of the adhesive tape and pulls it out to the position above the melt adhesive platform 306. After partially clamping the rear end of the adhesive tape, the adhesive tape cutter 303 gently lowers, cuts off the adhesive tape, and then the adhesive tape cutter 303 retracts. The rear end of the adhesive tape is vacated, and the adhesive tape chuck 302 comes over to grip the cut section, and pulls it out, repeating the above operation.

After the adhesive tape is precisely placed on the melt adhesive platform 306, the front and rear adhesive modules respectively control the positions of the two melt adhesive platforms 306 on both sides to swap their front-to-back positions. When they meet in the middle, the vertical sliding rails and vertical sliders 307 create a height difference between the left and right melt adhesive platforms 306, preventing collision. The melt adhesive platform 306 carrying the adhesive tape then moves backward to align with the half-cell silicon wafer, ensuring that a single adhesive tape fills the gap between the half-cell silicon wafers. Upon heating by the adhesive heating tube 308, the hot-melt adhesive tape bonds all silicon wafers together.

One end of the adhesive tapeslitting bracket 301 is rotatably connected to the adhesive tape feeding tray 309. The incoming adhesive tape is wound onto the feeding tray 309, with its end pulled out for sequential cutting.

The drive end of the adhesive tape transverse module 304 is provided with an adhesive tape pulling plate 310 and an adhesive tape cutting plate 311. The lower end of the adhesive tape pulling plate 310 is fitted with an adhesive tape front cylinder 312 and an adhesive tape front holder 313. The drive end of the adhesive tape front cylinder 312 is hinged to the adhesive tape chuck 302. The adhesive tapechuck 302 and front holder 313 grip the front end of the adhesive tape. The lower end of the adhesive tape cutting plate 311 houses the adhesive tape rear cylinder 314, adhesive tape cutting cylinder 315, and adhesive tape rear holder 316. The adhesive tape cutter 303 is mounted on the drive end of the adhesive tape cutting cylinder 315. The drive end of the adhesive tape rear cylinder 314 is connected to the adhesive tape rear holder 316 to hold the rear end of the adhesive tape. The adhesive tape transverse module 304 is provided with an adhesive tape transverse motor 317 and an adhesive tape transverse sliding rail 318. The drive end of the adhesive tapetransverse motor 317 is connected to an adhesive tape transverse synchronizing wheel 319, the adhesive tape transverse synchronizing wheel 319 is connected via a drive mechanism to the adhesive tape transverse synchronizingbelt 320. The adhesive tape pulling plate 310 and adhesive tape cutting plate 311 are respectively fixed on both sides of the adhesive tape transverse synchronizing belt 320. The adhesive tape pulling plate 310 and adhesive tape cutting plate 311 move toward or away from each other.

The adhesive tape transverse motor 317 controls the movement of the adhesive tape transverse synchronizingbelt 320. When the adhesive tapepulling plate 310 and the adhesive tape cutting plate 311 approach each other, the front cylinder 312 and the front holder 313 on the adhesive tape pulling plate 310 clamp one end of the adhesive tape held by the rear cylinder 314 and the rear holder 316. Subsequently, the adhesive tape pulling plate 310 and the adhesive tape cutting plate 311 separate from each other. The adhesive tape rear cylinder 314 and rear adhesive tape holder 316 release the adhesive tape, allowing it to be pulled to the appropriate position by the front adhesive tape cylinder 312 and front adhesive tape holder 313. After the melt adhesive platform 306 is lifted, the adhesive tape can be placed onto the melt adhesive platform 306. The adhesive tapecutting cylinder 315 controls the adhesive tape cutter 303 to descend and sever the adhesive tape. After release, the melt adhesive platform 306 lowers to the translation height. At this point, the adhesive tape rear cylinder 314 and adhesive tape rear holder 316 clamp the severed adhesive tape, while the adhesive tape pulling plate 310 and adhesive tape cutting plate 311 move closer to each other again. The above operation is repeated to perform the adhesive tape pulling action.

The lower end of the melt adhesive platform 306 is fixed with a melt adhesive vertical plate 321. A melt adhesive vertical motor 322 is mounted on the melt adhesive vertical plate 321. The melt adhesive vertical motor 322 is connected to a melt adhesive lifting screw 323 in a transmission way. A melt adhesive lifting nut has threaded connection to the melt adhesive lifting screw 323. The melt adhesive lifting nut is fixed to the adhesive tape transverse module 304. Both the lower end of the melt adhesive lifting screw 323 and the drive end of the melt adhesive vertical movement motor 322 are provided with melt adhesive lifting synchronizing wheels 324. A melt adhesive lifting synchronizing belt 325 is connected between the melt adhesive lifting synchronizing wheels 324 in a transmission way. The melt adhesive platform 306 is provided with a plurality of platform absorption holes 326. A platform air pipe joint 327 is connected to the outer side of the melt adhesive platform 306, with the platform absorption holes 326 communicating with the platform air pipe joint 327.

The two front-rear modules on the melt adhesive adhering bracket 305 move relative to each other in a front-rear, left-right, and high-low configuration without causing contact interference during motion. The front-rear orientation is controlled by the front-rear modules, while the left-right orientation is determined by their installation positions. The high-low orientation is controlled by the melt adhesive vertical motor 322. Rotation of the melt adhesive lifting screw 323 drives the entire melt adhesive vertical plate 321 to move up and down along the melt adhesive vertical sliding rail. When the adhesive tape reaches the melt adhesive platform 306, the negative pressure generated by the platform absorption hole 326 fixes the position of the half-cell silicon wafer, facilitating docking with the hot melt adhesive tape.

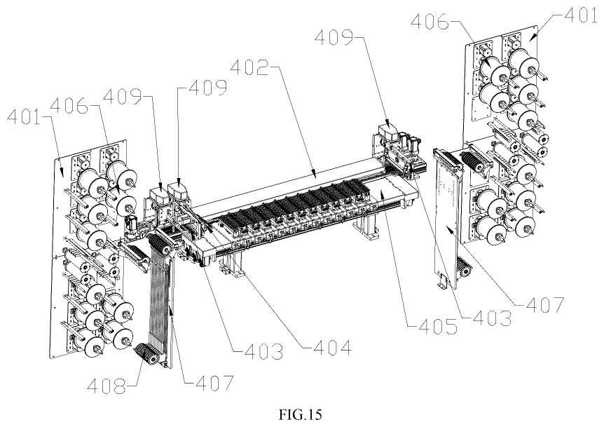

As shown in FIGS. 15 to 20, the wire cutting and placement mechanism 4 includes two wire feeders 401 and a welding wire transverse module 402. Two welding wire cutting assemblies 403, welding wire bidirectional clamping assemblies 404, and welding wire positioning brackets 405. The welding wire positioning bracket 405 is positioned between the two welding wire feeders 401. The two welding wire cutting assemblies 403 are respectively located above both ends of the welding wire positioning bracket 405. The bidirectional wire clamping assembly 404 is mounted on the drive end of the wire transverse module 402. The bidirectional wire clamping assembly 404 reciprocates between the two wire cutting assemblies 403, drawing the wire from the welding wire feeder 401 and placing it onto the wire positioning bracket 405.

Specifically, the welding wire feeder 401 is provided with multiple welding wire spools 406. A tensioning frame 407 is positioned between the welding wire feeder 401 and the welding wire positioning bracket 405. A tensioning wheel 408 is mounted on the tensioning frame 407. The wound welding wire is stored within the wire spool 406, with the left and right wire spools 406 respectively responsible for feeding welding wire for odd-numbered and even-numbered columns. The tensioning wheel 408 ensures that the drawn-out welding wire remains in a straight state.

Three wire lifting pedestals 409 are mounted on the wire transverse module 402. Each wire lifting pedestal 409 houses a welding wire lifting motor. These welding wire lifting motors control the rotation of welding wire lifting screws via synchronizing wheels and synchronizing belts. Welding wire cutting assemblies 403 and a set of welding wire bidirectional clamping assemblies 404 each have welding wire lifting nuts installed on their rear sides. The welding wire lifting screws are connected to the welding wire lifting nuts in a transmission way. Both the welding wire cutting assemblies 403 and the welding wire bidirectional clamping assemblies 404 move vertically along the welding wire lifting sliding rails.

Under the action of the welding wire lifting pedestal 409, when the left-side welding wire is pulled, the left-side wire cutting assembly 403, in coordination with the bidirectional wire clamping assembly 404, lowers the welding wire onto the welding wire positioning bracket 405 to maintain its horizontal state. Similarly, when the right-side welding wire is pulled, after the welding wire is lowered, the wire cutting assembly 403 severs the welding wire, simultaneously drawing out a new welding wire from the opposite side. When reciprocating left and right, the bidirectional wire clamping assembly 404 continuously draws out the welding wires from both sides.

The wire cutting assembly 403 includes a welding wire slitting bracket 410, a welding wire cutting motor 411, and a welding wire cutting vertical plate 412. The welding wire cutting vertical plate 412 moves vertically along the welding wire slitting bracket 410. A wire cutting guide hole is provided at the upper end of the welding wire cutting vertical plate 412. The drive end of the welding wire cutting motor 411 is fitted with a welding wire cutting cam 413, which operates within the welding wire cutting guide hole. A welding wire cutter 414 is mounted at the lower end of the wire cutting vertical plate 412. Welding wire cutting sliders 415 are mounted on both sides of the welding wire cutting vertical plate 412. Welding wire cutting sliders are fixed on both sides of the welding wire slitting bracket 410, and the welding wire cutting sliders 415 slide along the welding wire cutting sliding rails.

After the welding wire is pulled out, the welding wire cutting motor 411 drives the welding wire cutting cam 413 to rotate, causing the welding wire cutting vertical plate 412 to press downward along the welding wire cutting sliding rails. The welding wire cutter 414 then severs the welding wire mounted on the welding wire slitting bracket 410.

The bidirectional welding wire clamping assembly 404 includes a welding wire clamping support 416 and a welding wire sliding shaft 417. A row of welding wire lower clamps 418 and a row of welding wire upper clamps 419 are mounted on each side of the welding wire clamping support 416, wherein the welding wire lower clamps 418 are fixed to the welding wire clamping support 416, and an internal support cavity is provided within the welding wire clamping support 416. The upper end of the support cavity is connected to a support air pipe joint 420. The welding wire sliding shaft 417 moves transversely within the support cavity, and the welding wire upper clamps 419 are hinged to the end of the welding wire sliding shaft 417.

The welding wire holding support 416 moves back and forth horizontally above the wire positioning bracket 405 under the action of the wire transverse module 402, clamping the welding wires from the left and right welding wire feeders 401. The support air pipe joint 420 controls the internal gas within the support cavity, causing the welding wire shaft 417 to extend and retract. The hinged connection allows the welding wire upper clamp 419 and lower welding wire clamp 418 to grip the ends of the welding wire.

A welding wire positioning motor 421 and a welding wire positioning synchronizing wheel 422 are mounted at the end of the wire positioning bracket 405. The drive end of the wire positioning motor 421 is connected to the wire positioning synchronizing wheel 422. The wire positioning synchronizing wheel 422 is connected to the wire positioning synchronizing belt 423 in a transmission way. Several welding wire positioning seats 424 are fixedly connected to the welding wire positioning synchronizing belt 423. The welding wire positioning seats 424 slide horizontally on the welding wire positioning bracket 405. A welding wire positioning cylinder 425 is mounted at the upper end of the welding wire positioning seat 424. The drive end of the welding wire positioning cylinder 425 vertically connects upward to a wire positioning plate 426. A welding wire positioning clamp 427 is hinged to the welding wire positioning seat 424, and the lower end of the welding wire positioning clamp 427 is engaged by clamping onto the wire positioning plate 426.

The welding wire positioning motor 421 controls the position of each welding wire positioning seat 424 via the wire positioning synchronizing wheel 422 and wire positioning synchronizing belt 423, meeting the requirements for positioning and clamping the welding wire. After the upper bidirectional welding wire clamping assembly 404 pulls the welding wire out and places it onto the wire positioning seat 424, the wire positioning cylinder 425 pushes the wire positioning plate 426 upward. The lower end of the wire positioning clamp 427 hinges under applied force, and the upper end of the wire positioning clamp 427 converges to clamp and secure the welding wire.

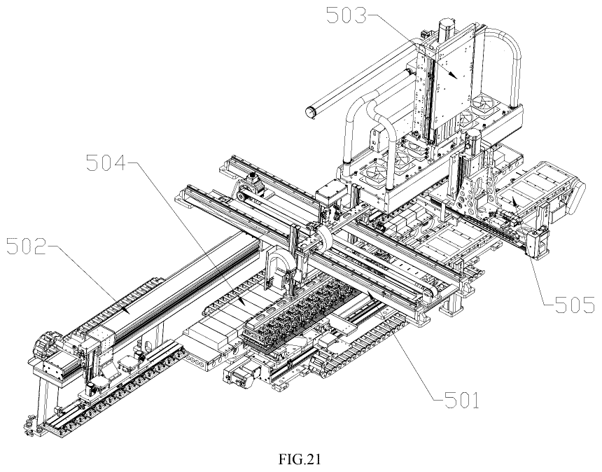

As shown in FIGS. 21 to 28, the welding wire welding mechanism 5 includes a welding wire transfer structure 501, a silicon wafer transfer structure 502, an infrared welding structure 503, a welding support structure 504, and a string welding blanking structure 505, wherein the wire transfer structure 501 picks up the wire and places it onto the welding support structure 504; the silicon wafer transfer structure 502 places the silicon wafer array connected to the adhesive tape onto the welding support structure 504 holding the wire; the welding support structure 504 moves the silicon wafer array together with the wire to the position below the infrared welding structure 503 for string welding; and the string welding blanking structure 505 removes the string-welded silicon wafers.

Specifically, the welding wire transfer structure 501 includes a welding wire transfer transverse module 506 and a welding wire transfer longitudinal module 507, wherein the welding wire transfer longitudinal module 507 is installed on the drive end of the welding wire transfer transverse module 506, a plurality of groups of welding wire transfer holders 508 are installed on the drive end of the welding wire transfer longitudinal module 507, and a welding wire transfer cylinder 509 is installed in the middle of the welding wire transfer holder 508. The drive endof the welding wire transfer cylinder 509 is connected with a welding wire transfer stop plate 510, and the lower end of the welding wire transfer stop plate 510 is provided with a welding wire transfer V-shaped groove 511; the lower end of the welding wire transfer clamp holder 508 is hinged with a welding wire transfer clamp 512, and the upper end of the welding wire transfer clamp 512 is clamped in the welding wire transfer V-shaped groove 511;

One side of the welding wire transfer holder 508 is provided with a welding wire transfer sensor 513, and one side of the welding wire transfer stop plate 510 is provided with a welding wire transfer signal wafer 514, and the welding wire transfer signal wafer 514 is connected with the welding wire transfer sensor 513.

When a cut welding wire is picked up from the cutting and placing mechanism, the welding wire transfer cylinder 509 controls the welding wire transfer stop plate 510 to move up and down, so that the height of the welding wire transfer V-shaped groove 511 is changed, the corresponding welding wire transfer clamp 512 can be actually opened or closed to clamp the welding wire, and the height of the corresponding welding wire transfer stop plate 510 is known from the welding wire transfer sensor 513 so that the welding wire is properly picked and placed, and then the welding wire is transferred to the welding support structure 504 under the joint action of the welding wire transfer transverse module 506 and the welding wire transfer longitudinal module 507.

The silicon wafer transfer structure 502 includes a silicon wafer transfer transverse module 515 and a silicon wafer transfer longitudinal module 516. The silicon wafer transfer longitudinal module 516 is mounted on the drive end of the silicon wafer transfer transverse module 515. Along the front-to-back direction on the drive end of the silicon wafer transfer longitudinal module 516, a plurality of silicon wafer transfer suction nozzles 517 are distributed.

After the welding wire is placed on the welding support structure 504, the silicon wafer transfer transverse module 515 and the silicon wafer transfer longitudinal module 516 jointly control the transfer of the silicon wafer bonded by the adhesive tape onto the welding support structure 504. The silicon wafer is then placed onto the welding wire via the silicon wafer transfer suction nozzle 517.

The infrared welding structure 503 includes an infrared lifting module 518. The drive end of the infrared lifting module 518 is connected to an infrared welding frame 519. Several infrared lamps are distributed inside the infrared welding frame 519, and an air duct 520 is installed at the upper end of the infrared welding frame 519. A plurality of exhaust fans 521 are mounted on the infrared welding frame 519.

During string welding, the infrared lifting module 518 controls the entire infrared welding frame 519 to descend. Infrared lamps are used to perform string welding on the silicon wafer and welding wire. After heating and welding, heat dissipation is achieved using exhaust fans 521, with air expelled through the air duct 520 to facilitate subsequent accelerated processing.

The welding support structure 504 includes two welding support front-rear modules 522. Each of welding support front-rear modules 522 has a welding support left-right module installed at its drive end. A welding positioning module 523 is fixed to the drive end of the welding support left-right module. The welding support left-right modules include welding support left-right motors 524, welding support left-right screws, and a welding support side table 525. Both the drive ends of the welding support left-right motors 524 and the ends of the welding support left-right screws are fitted with welding support left-right synchronizing wheels 526. A welding support left-right synchronizing belt 527 is connected between the welding support left-right synchronizing wheels 526 in a transmission way. A welding support left-right nut is fixed on the welding support side table 525, with the welding support left-right nut threadedly engaging the welding support left-right screw. A welding support left-right slider is fixed on the welding support front-rear module 522, and a welding support left-right sliding rail 528 is fixed at the lower end of the welding support side table 525. The left and right sliders of the welding support slide along the left and right sliding rails 528 of the welding support. The welding positioning module 523 is positioned on the welding support side table 525.

Under the action of two welding support front and rear modules 522, the former set of welding positioning modules 523 dock with the welding wire and the silicon wafer, and the latter set of welding positioning modules 523 have been welded under the infrared welding structure 503 without affecting the efficiency. After the string-welded silicon wafers are taken away, the two welding support front and rear modules 522 exchange positions, and in the middle, the left and right modules are welded and supported. The welding support left and right motors 524 control the left and right screws of the welding support to rotate. Driven by the welding support left and right sliding rails 528, the two welding support long tables 525 move to the outside respectively, so as to vacate the interconnection space in the middle, and the two welding support long tables 525 will not collide, so that the front and rear positions can be exchanged and the efficiency and progress of string welding can be accelerated.

The string welding blanking structure 505 includes a string welding blanking transverse module 529, a string welding blanking vertical module 530 and a string welding blanking track 531, wherein the string welding blanking vertical module 530 is installed on the drive end of the string welding blanking transverse module 529, and the drive end of the string welding blanking vertical module 530 is provided with a plurality of string welding blanking suction nozzles 532 along the front-back direction, and the string welding blanking track 531 is provided with a plurality of blanking absorption holes 533. The side of the string welding blanking track 531 is arranged with a blanking air pipe, and the blanking air pipe is connected to the blanking adsorption hole 533.

The silicon wafer after infrared string welding is absorbed by the string welding blanking suction nozzle 532 controlled by the string welding blanking transverse module 529 and the string welding blank vertical module 530 and then placed on the string welding blanking track 531. After the negative pressure control of the blanking gas pipe, the string welding silicon wafer is fixedly output through the blanking adsorption hole 533.

All modules described in this application are linear modules.

It should be noted that the above specific implementation methods merely represent preferred embodiments of the present invention and the technical principles employed. Within the scope of the disclosed technology, any modifications or substitutions readily conceivable by those skilled in the art should be encompassed within the scope of protection of the present invention.

What is claimed is:

1. A BC cell string welding machine for half-cells, welding wires, and adhesive tapes, including a silicon wafer handling mechanism, a silicon wafer flipping and turning mechanism, a silicon wafer and adhesive tape assembly mechanism, a welding wire cutting and placement mechanism, and a welding wire welding mechanism; the silicon wafer handling mechanism performs warming and heating treatment on laser-cut dual half-cells; the wafer flipping and turning mechanism flips the dried dual half-cells, separates, turns and positions them for photographic inspection; the silicon wafer and adhesive tape assembly mechanism cuts the stretched adhesive tape and adheres it between the half-cells via hot melting; the wire cutting and placement mechanism undertakes pull-out and cutting of odd-numbered and even-numbered column welding wires on the left and right sides respectively, ensuring wire positioning; the welding wire welding mechanism places the cut welding wires beneath and positions the adhesive-bonded cell strings for string welding.

2. A BC cell string welding machine for half-cells, welding wires, and adhesive tapes, as claimed in claim 1, wherein the silicon wafer handling mechanism includes a half-cell handling bracket, a handling translation module, and a drying heating chamber; the half-cell handling bracket is fixed with a handling support plate, the handling support plate features handling fixation absorption holes distributed along the front-to-back direction; a handling lifting motor is mounted on the drive end of the handling translation module, with a handling lifting cam connected to the drive end of the handling lifting motor; a handling lifting module is positioned beneath the handling support platform; the upper end of the handling lifting module connects to a handling slat and the handling slat is positioned centrally on the handling support plate; the handling lifting cam controls the vertical movement of the handling slat; the drying heating chamber is mounted above the handling support plate.

3. A BC cell string welding machine for half-cells, welding wires, and adhesive tapes, as claimed in claim 2, wherein the drying heating chamber is fixed on both sides at the center of the handling support plate, a drying heating rod is installed inside the drying heating chamber, a vent plate is provided above the drying heating rod, and a drying heating cooling fan is installed above the drying heating chamber.

4. A BC cell string welding machine for half-cells, welding wires, and adhesive tapes, as claimed in claim 1, wherein the silicon wafer flipping mechanism includes a flipping bracket, a translation clamping bracket, a half-cell turning X-axis module, a half-cell turning Z-axis module, and a half-cell converging bracket; the flipping bracket is rotatably connected to a flipping shaft, and the flipping frame is fixed on the flipping shaft; the translation clamping bracket has translation slats on both sides, and the translation belt moves on the translation slats, with translation absorption holes provided on the translation belt; the translation clamping arms are mounted on both sides of the translation slats, with translation clamping wheels installed on the clamping arms; the half-cell turning Z-axis module is mounted on the drive end of the half-cell turning X-axis module; two turning cylinders are movably mounted along the Y-axis direction on the drive end of the half-cell turning Z-axis module, with turning suction cups connected to the drive ends of the turning cylinders; the end of the half-cell converging bracket is provided with a converging base frame, with converging arms installed on both sides and the rear of the converging base frame.

5. A BC cell string welding machine for half-cells, welding wires, and adhesive tapes, as claimed in claim 4, wherein the converging base frame is provided with converging front and rear sliding rails, converging left and right sliding rails and converging synchronizing wheels, and the converging synchronizing wheels are connected with a converging synchronizing belt in a transmission way, the converging synchronizing belt is connected with the converging arm at the rear side, the converging arm at the rear side slides on the converging front and rear sliding rails, and a converging fixing plate is fixed on the converging arm at the rear side; the converging fixing plate is provided with a converging guide groove, the converging arms at two sides slide on the converging left and right sliding rails, the converging arms at two sides are provided with converging guide wheels, and the converging guide wheels move in the converging guide grooves.

6. A BC cell string welding machine for half-cells, welding wires, and adhesive tapes, as claimed in claim 1, wherein the assembly mechanism of silicon wafers and adhesive tapes includes an adhesive tape slitting structure and a melt adhesive conveying structure; the adhesive tape slitting structure includes an adhesive tape slitting bracket, an adhesive tape chuck and an adhesive tape cutter, wherein an adhesive tape transverse module is installed on the adhesive tape slitting bracket along the left and right directions, and the adhesive tape chuck and the adhesive tape cutter are both connected to the drive end of the adhesive tape transverse module; the melt adhesive conveying structure includes a melt adhesive adhering bracket and a melt adhesive platform, wherein the melt adhesive adhering bracket is provided with two melt adhesive front and rear modules along the front and rear directions, the drive ends of each group of melt adhesive front and rear modules are provided with a melt adhesive vertical sliding rail, and a melt adhesive vertical slider is connected below the melt adhesive platform, the melt adhesive vertical slider slides on the melt adhesive vertical sliding rail, and the melt adhesive platform is internally inserted witha melt adhesive heating tube.

7. A BC cell string welding machine for half-cells, welding wires, and adhesive tapes, as claimed in claim 6, wherein the drive end of the adhesive tape transverse module is provided with an adhesive tape pulling plate and an adhesive tape cutting plate; the lower end of the adhesive tape pulling plate is fitted with an adhesive tape front cylinder and an adhesive tape front holder; the drive end of the adhesive tape front cylinder is hinged to the adhesive tape chuck, wherein the adhesive tape chuck and the front adhesive tape holder clamp the front end of the adhesive tape; the lower end of the adhesive tape cutting plate is mounted with a adhesive tape rear cylinder, an adhesive tape cutting cylinder, and a rear adhesive tape holder; the adhesive tape cutter is mounted on the drive end of the adhesive tape cutting cylinder, and the drive end of the adhesive tape rear cylinder and the rear adhesive tape holder clamp the rear end of the adhesive tape.

8. A BC cell string welding machine for half-cells, welding wires, and adhesive tapes, as claimed in claim 1, wherein the welding wire cutting and placement mechanism includes two welding wire feeders, a welding wire transverse module, two welding wire cutting assemblies, a welding wire bidirectional clamping assembly, and a welding wire positioning bracket; the welding wire positioning bracket is positioned between the two welding wire feeders, with the two wire cutting assemblies positioned above both ends of the wire positioning bracket; the bidirectional wire clamping assembly is mounted on the drive end of the wire transverse module, reciprocating between the two wire cutting assemblies to draw a wire from the wire feeder and place it onto the wire positioning bracket.

9. A BC cell string welding machine for half-cells, welding wires, and adhesive tapes, as claimed in claim 8, wherein the bidirectional welding wire clamping assembly includes a welding wire clamping support and a welding wire sliding shaft; a row of welding wire lower clamps and a row of welding wire upper clamps are mounted on each side of the welding wire clamping support, wherein the welding wire lower clamps are fixed to the welding wire clamping support, and an internal support cavity is provided within the welding wire clamping support; the upper end of the support cavity is connected to a support air pipe joint; the welding wire sliding shaft moves transversely within the support cavity, and the welding wire upper clamps are hinged to the end of the welding wire sliding shaft.

10. A BC cell string welding machine for half-cells, welding wires, and adhesive tapes, as claimed in claim 1, wherein the welding wire welding mechanism includes a welding wire transfer structure, a silicon wafer transfer structure, an infrared welding structure, a welding support structure, and a string welding blanking structure; wherein the wire transfer structure picks up the wire and places it onto the welding support structure; the silicon wafer transfer structure places the silicon wafer array connected to the adhesive tape onto the welding support structure holding the wire; the welding support structure moves the silicon wafer array together with the wire to the position below the infrared welding structure for string welding; and the string welding blanking structure removes the string-welded silicon wafers.
